(19) United States
(12) Patent Application Publication
(10) Pub. No.: US 2025/0229169 A1
(43) Pub. Date: Jul. 17, 2025

(54) PUZZLE TABLE

(71) Applicant: Meng Zhang, Shenzhen (CN)

(72) Inventors: Meng Zhang, Shenzhen (CN); Xiaoling Che, Dangyang (CN); Xiaoyi Che, Dangyang (CN); Jinyan Duan, Shenzhen (CN)

(21) Appl. No.: 19/095,077

(22) Filed: Mar. 31, 2025

Related U.S. Application Data
(63) Continuation-in-part of application No. 19/011,676, filed on Jan. 7, 2025.
Application No. 19/011,676 is a continuation of application No. 18/734,521, filed on Jun. 5, 2024, now Pat. No. 12,239,914.
Application No. 18/734,521 is a continuation-in-part of application No. 18/541,685, filed on Dec. 15, 2023, now Pat. No. 12,042,740.
Application No. 18/541,685 is a continuation of application No. 17/505,587, filed on Oct. 19, 2021, now Pat. No. 11,890,551.
Application No. 18/734,521 is a continuation-in-part of application No. 18/530,402, filed on Dec. 6, 2023, now Pat. No. 12,053,709.
Application No. 18/530,402 is a continuation-in-part of application No. 17/505,587, filed on Oct. 19, 2021, now Pat. No. 11,890,551.
Application No. 17/505,587 is a continuation-in-part of application No. 18/235,416, filed on Aug. 18, 2023, now Pat. No. 12,059,631.
Application No. 18/734,521 is a continuation-in-part of application No. 18/235,416, filed on Aug. 18, 2023, now Pat. No. 12,059,631.
Application No. 18/235,416 is a continuation-in-part of application No. 17/505,587, filed on Oct. 19, 2021, now Pat. No. 11,890,551.
(63) Continuation-in-part of application No. 18/956,131, filed on Nov. 22, 2024.
Application No. 18/956,131 is a continuation of application No. 18/732,602, filed on Jun. 3, 2024, now Pat. No. 12,186,676.
Application No. 18/732,602 is a continuation of application No. 18/541,685, filed on Dec. 15, 2023, now Pat. No. 12,042,740.
(63) Continuation-in-part of application No. 18/764,239, filed on Jul. 4, 2024, now Pat. No. 12,274,356.
(63) Continuation-in-part of application No. 18/761,350, filed on Jul. 2, 2024.
Application No. 18/761,350 is a continuation of application No. 18/737,905, filed on Jun. 7, 2024.
Application No. 18/737,905 is a continuation-in-part of application No. 18/541,685, filed on Dec. 15, 2023, now Pat. No. 12,042,740.
Application No. 18/541,685 is a continuation of application No. 18/235,416, filed on Aug. 18, 2023, now Pat. No. 12,059,631.
Application No. 18/761,350 is a continuation-in-part of application No. 18/541,685, filed on Dec. 15, 2023, now Pat. No. 12,042,740.
(63) Continuation-in-part of application No. 18/755,730, filed on Jun. 27, 2024.
Application No. 18/755,730 is a continuation of application No. 18/748,158, filed on Jun. 20, 2024.
Application No. 18/748,158 is a continuation of application No. 18/530,402, filed on Dec. 6, 2023, now Pat. No. 12,053,709.
Application No. 18/530,402 is a continuation-in-part of application No. 18/235,416, filed on Aug. 18, 2023, now Pat. No. 12,059,631.
Application No. 18/755,730 is a continuation-in-part of application No. 18/530,402, filed on Dec. 6, 2023, now Pat. No. 12,053,709.
Application No. 18/530,402 is a continuation-in-part of application No. 18/235,416, filed on Aug. 18, 2023, now Pat. No. 12,059,631.
(63) Continuation-in-part of application No. 18/748,158, filed on Jun. 20, 2024.
(63) Continuation-in-part of application No. PCT/CN2024/100328, filed on Jun. 20, 2024.

(30) Foreign Application Priority Data
Sep. 26, 2021 (CN) 202111131554.1
Sep. 26, 2021 (CN) 202122334815.1
Feb. 8, 2024 (CN) 202420292101.X
Apr. 29, 2024 (CN) 202420950719.0
Jan. 25, 2025 (CN) 202520174454.4
Feb. 10, 2025 (CN) 202520211034.9

(51) Int. Cl. A63F 9/10; F16M 11/04

(52) U.S. Cl. CPC A63F 9/1044; A63F 9/10; A63F 2009/105; F16M 11/046

(57) ABSTRACT

A puzzle table includes: a table body; a rotation bracket; and at least one support bracket. The rotation bracket is mounted on and is parallel to a bottom surface of the table body. The rotation bracket is configured to enable the table body to rotate on a horizontal plane. The at least one support bracket is rotatably mounted on the table body. The at least one support bracket has an in-use state and a folded state; when the at least one support bracket is in the in-use state, the at least one support bracket abuts against a placement surface; and when the at least one support bracket is in the folded state, the at least one support bracket swings to be substantially parallel to the bottom surface of the table body, and the rotation bracket abuts against the placement surface.

### CROSS REFERENCE TO RELATED APPLICATIONS

The present application is a continuation of the followings:

(i) a continuation-in-part (CIP) of U.S. application Ser. No. 19/011,676 (pending), filed on Jan. 7, 2025.

The U.S. application Ser. No. 19/011,676 is continuation of U.S. application Ser. No. 18/734,521, filed on Jun. 5, 2024, now U.S. Pat. No. 12,239,914.

The U.S. application Ser. No. 18/734,521 is continuation-in-part of U.S. application Ser. No. 18/541,685, filed on Dec. 15, 2023, now U.S. Pat. No. 12,042,740.

The U.S. application Ser. No. 18/541,685 is continuation of U.S. application Ser. No. 17/505,587, filed on Oct. 19, 2021, now U.S. Pat. No. 11,890,551.

The U.S. application Ser. No. 18/734,521 is continuation-in-part of U.S. application Ser. No. 18/530,402, filed on Dec. 6, 2023, now U.S. Pat. No. 12,053,709.

The U.S. application Ser. No. 18/530,402 is continuation-in-part of U.S. application Ser. No. 17/505,587, filed on Oct. 19, 2021, now U.S. Pat. No. 11,890,551.

The U.S. application Ser. No. 18/530,402 is continuation-in-part of U.S. application Ser. No. 18/235,416, filed on Aug. 18, 2023, now U.S. Pat. No. 12,059,631.

The U.S. application Ser. No. 18/734,521 is continuation-in-part of the U.S. application Ser. No. 18/235,416, filed on Aug. 18, 2023, now U.S. Pat. No. 12,059,631.

The U.S. application Ser. No. 18/235,416 is continuation-in-part of U.S. application Ser. No. 17/505,587, filed on Oct. 19, 2021, now U.S. Pat. No. 11,890,551.

(ii) a continuation-in-part (CIP) of U.S. application Ser. No. 18/956,131 (pending), filed on Nov. 22, 2024.

The U.S. application Ser. No. 18/956,131 is continuation of U.S. application Ser. No. 18/732,602, filed on Jun. 3, 2024, now U.S. Pat. No. 12,186,676.

The U.S. application Ser. No. 18/732,602 is continuation of U.S. application Ser. No. 18/541,685, filed on Dec. 15, 2023, now U.S. Pat. No. 12,042,740.

The U.S. application Ser. No. 18/541,685 is continuation of U.S. application Ser. No. 17/505,587, filed on Oct. 19, 2021, now U.S. Pat. No. 11,890,551.

(iii) a continuation-in-part (CIP) of U.S. application Ser. No. 18/764,239 (pending), filed on Jul. 4, 2024.

(iv) a continuation-in-part (CIP) of U.S. application Ser. No. 18/761,350 (pending), filed on Jul. 2, 2024.

The U.S. application Ser. No. 18/761,350 is continuation of U.S. application Ser. No. 18/737,905 (pending), filed on Jun. 7, 2024.

The U.S. application Ser. No. 18/737,905 is continuation-in-part of U.S. application Ser. No. 18/541,685, filed on Dec. 15, 2023, now U.S. Pat. No. 12,042,740.

The U.S. application Ser. No. 18/737,905 is continuation of U.S. application Ser. No. 18/235,416, filed on Aug. 18, 2023, now U.S. Pat. No. 12,059,631.

The U.S. application Ser. No. 18/761,350 is continuation-in-part of U.S. application Ser. No. 18/541,685, filed on Dec. 15, 2023, now U.S. Pat. No. 12,042,740.

(v) a continuation-in-part (CIP) of U.S. application Ser. No. 18/755,730 (pending), filed on Jun. 27, 2024.

The U.S. application Ser. No. 18/755,730 is continuation of U.S. application Ser. No. 18/748,158 (pending), filed on Jun. 20, 2024.

The U.S. application Ser. No. 18/748,158 is continuation of U.S. application Ser. No. 18/530,402, filed on Dec. 6, 2023, now U.S. Pat. No. 12,053,709.

The U.S. application Ser. No. 18/748,158 is continuation-in-part of U.S. application Ser. No. 18/235,416, filed on Aug. 18, 2023, now U.S. Pat. No. 12,059,631.

The U.S. application Ser. No. 18/755,730 is continuation-in-part of U.S. application Ser. No. 18/530,402, filed on Dec. 6, 2023, now U.S. Pat. No. 12,053,709.

The U.S. application Ser. No. 18/755,730 is continuation-in-part of U.S. application Ser. No. 18/235,416, filed on Aug. 18, 2023, now U.S. Pat. No. 12,059,631.

(vi) a continuation-in-part (CIP) of U.S. application Ser. No. 18/748,158 (pending), filed on Jun. 20, 2024.

(vii) a continuation-in-part (CIP) of U.S. Application No. PCT/CN2024/100328 (pending), filed on Jun. 20, 2024.

### TECHNICAL FIELD

Embodiments of the present disclosure relate to the technical field of tools for jigsaw puzzles, and more specifically, to a puzzle table.

### BACKGROUND

A jigsaw puzzle, as a puzzle game, plays an important role in intellectual development for children. In order to better allow a user to tile puzzle pieces, puzzle tables are provided to carry the puzzle pieces.

However, the puzzle tables in the art has only one usage mode, and therefore, the puzzle tables can be applied to a limited number of application scenarios.

### SUMMARY

The present disclosure provides a puzzle table, including: a table body; a rotation bracket; and at least one support bracket. The rotation bracket is mounted on and is parallel to a bottom surface of the table body. The rotation bracket is configured to enable the table body to rotate on a horizontal plane. The at least one support bracket is rotatably mounted on the table body. The at least one support bracket has an in-use state and a folded state; when the at least one support bracket is in the in-use state, the at least one support bracket abuts against a placement surface; and when the at least one support bracket is in the folded state, the at least one support bracket swings to be substantially parallel to the bottom surface of the table body, and the rotation bracket abuts against the placement surface.

### BRIEF DESCRIPTION OF THE DRAWINGS

In order to more clearly illustrate technical solutions in embodiments of the present disclosure, accompanying drawings used in the embodiments will be briefly introduced below. Obviously, the accompanying drawings in the following description show only some of the embodiments of the present disclosure, and any ordinary skilled person in the art may obtain other accompanying drawings based on these drawings without creative work.

FIG. 1 is a structural schematic view of a puzzle table according to an embodiment of the present disclosure, where a side support bracket and a central support bracket are in a folded state.

FIG. 2 is a plane view of a bottom of the puzzle table, where a rotation axis of the side support bracket and a rotation axis of the central support bracket are shown.

FIG. 3 is a structural schematic view of a rotation bracket abutting against a placement platform according to an embodiment of the present disclosure.

FIG. 4 is a structural schematic view of the side support bracket abutting against the placement platform according to an embodiment of the present disclosure.

FIG. 5 is a structural schematic view of the central support bracket abutting against the placement platform according to an embodiment of the present disclosure.

FIG. 6 is an enlarged view of a portion A shown in FIG. 1.

FIG. 7 is an enlarged view of a portion B shown in FIG. 1.

FIG. 8 is a structural schematic view of drawers being in two states when the side support bracket is in use, according to an embodiment of the present disclosure.

FIG. 9 is a structural schematic view of the bottom of the puzzle table where two side support brackets are in use, according to an embodiment of the present disclosure.

FIG. 10 is a structural schematic view of the central support bracket being in use, according to an embodiment of the present disclosure.

FIG. 11 is a structural schematic view of a table body and the rotation bracket according to an embodiment of the present disclosure.

FIG. 12 is an exploded view of the table body according to an embodiment of the present disclosure.

FIG. 13 is an enlarged view of a portion C shown in FIG. 11.

FIG. 14 is a structural schematic view of connection between a long rod and a side rod according to an embodiment of the present disclosure.

FIG. 15 is a structural schematic view of connection between a first reinforcing rod and the side rod according to an embodiment of the present disclosure.

FIG. 16 is a structural schematic view of a limiting protrusion abutting against an abutting wall according to an embodiment of the present disclosure.

FIG. 17 is a structural schematic view of a snap tab arranged on the drawer according to an embodiment of the present disclosure.

FIG. 18 is a cross-sectional view of a frame according to an embodiment of the present disclosure, where the long rod, the side rod, the first reinforcing rod, and a second reinforcing rod are hollow.

### REFERENCE NUMERALS IN THE DRAWINGS

Table body 1, bottom surface 101 of the table body, storage slot 102, limiting protrusion 103, frame 11, table board 12, drawer 13, first reinforcing rod 14, second reinforcing rod 15, long rod 111, side rod 112, mounting groove 1111, snap slot 1112, connection portion 1121, snap hook 1122, snap slot 1123, snap tab 131;

Rotation bracket 2, rotation axis 201 of the rotation bracket, fixation shell 21, base 22;

Support bracket 3, side support bracket 31, central support bracket 32, rotation axis 310 of the side support bracket, support leg 311, intermediate connection rod 312, side 3111 of the support leg away from the table body, positioning groove 3112, connection protrusion 3113, fixation groove 3114, abutting wall 3115, side 3101 of the side support bracket away from the table body, rotation axis 320 of the central support bracket;

First blocking member 4;

Limiting gear lever 5;

Second blocking member 6.

### DETAILED DESCRIPTIONS

Unless otherwise defined, all technical and scientific terms used herein have the same meaning as commonly understood by any ordinary skilled person in the. The terms used herein in the specification of the present disclosure are used only for the purpose of describing specific embodiments and are not intended to limit the present disclosure. Terms “include”, “have”, and any variations thereof in the specification, claims and the accompanying drawings of the present disclosure are intended to cover non-exclusive inclusion. Terms “first”, “second”, and so on in the specification, claims, and the drawings of the present disclosure are used to distinguish between different objects and are not intended to describe a particular order.

Reference to “embodiments” herein implies that particular features, structures or characteristics described in an embodiment may be included in at least one embodiment of the present disclosure. Presence of the phrase at various sections in the specification does not necessarily refer to one same embodiment nor a separate or alternative embodiment that is mutually exclusive of other embodiments. Any ordinary skilled person in the art shall understand, both explicitly and implicitly, that the embodiments described herein may be combined with other embodiments.

In order to enable any ordinary skilled person in the art to better understand the embodiments of the present disclosure, technical solutions in the embodiments of the present disclosure will be clearly and completely described below by referring to the accompanying drawings.

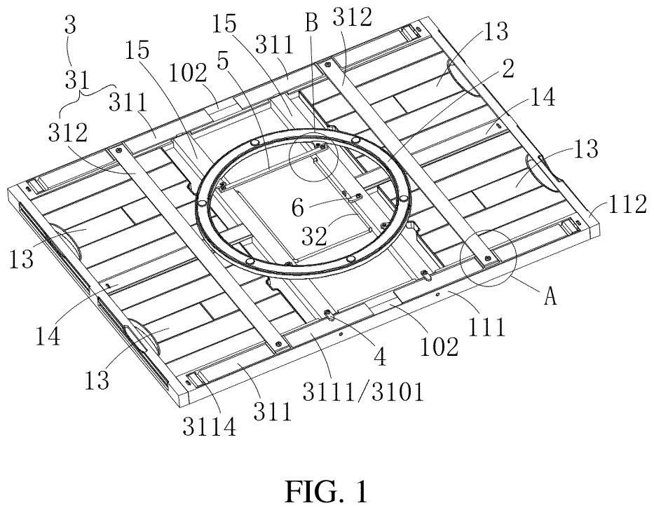

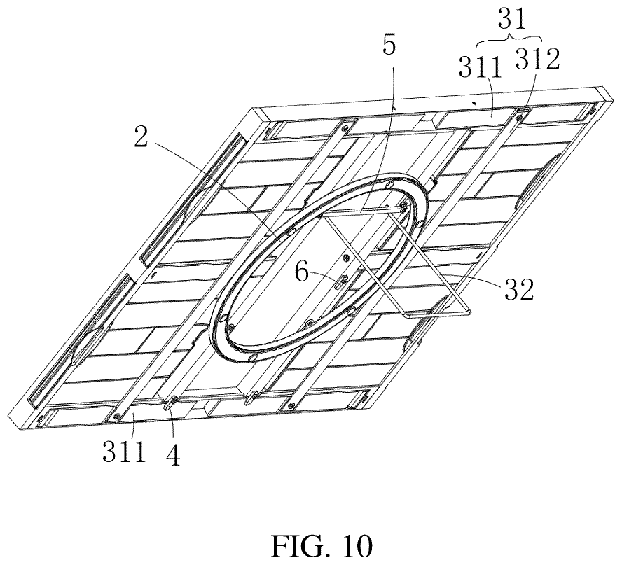

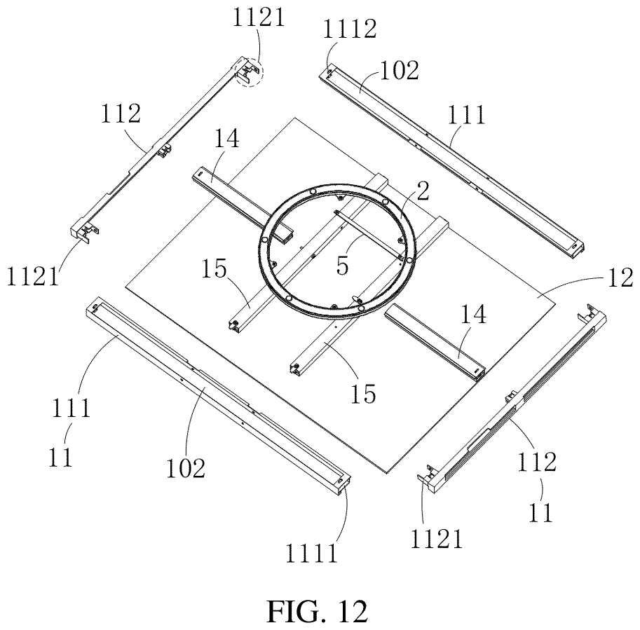

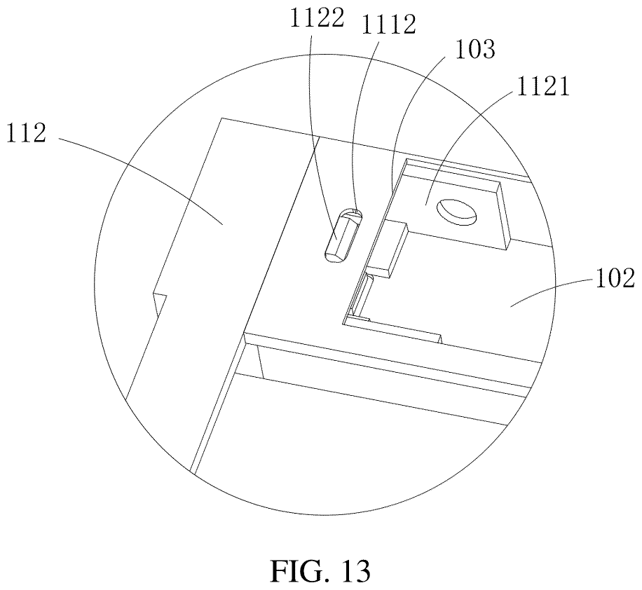

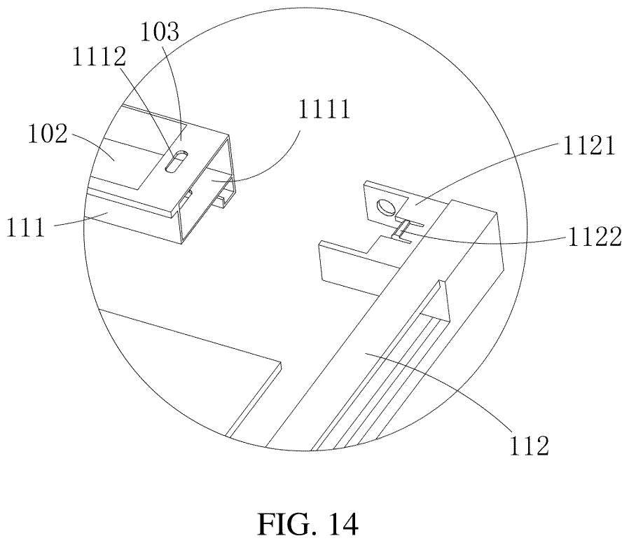

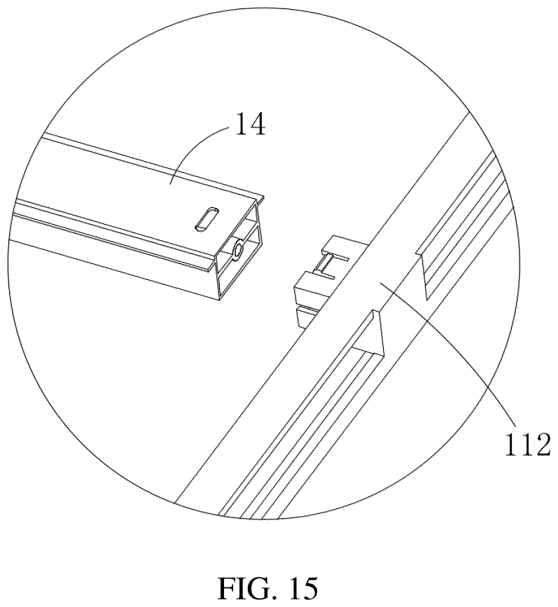

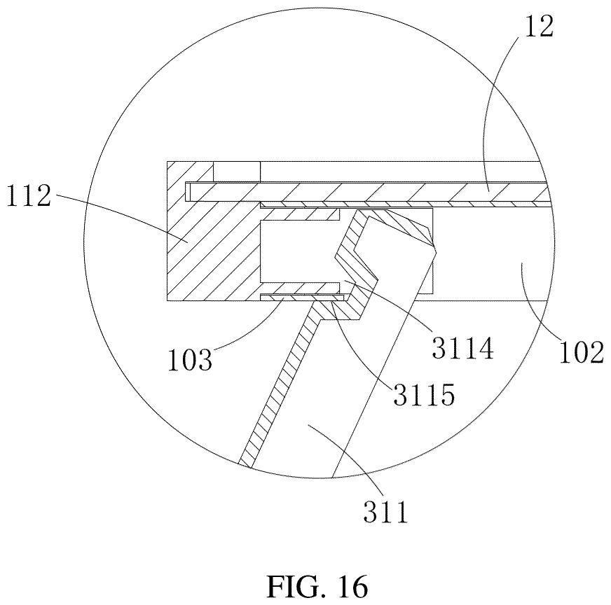

As shown in FIGS. 1 to 18, the present disclosure provides a puzzle table including a table body 1, a rotation bracket 2 and at least one support bracket 3.

The table body 1 is configured to carry and store puzzle pieces. The rotation bracket 2 is mounted on and is parallel to a bottom surface 101 of the table body 1. The rotation bracket 2 enables the table body 1 to rotate on a horizontal plane.

The at least one support bracket 3 is rotatably mounted on the table body 1. The at least one support bracket 3 has an in-use state and a folded state. When the at least one support bracket 3 is in the in-use state, the at least one support bracket 3 abuts against a placement surface, such as the floor, a tabletop, and so on. In this case, the rotation bracket 2 is located away from the placement surface, and the table body 1 may be inclined with respect to the placement surface or lifted up with respect to the placement surface. A state of the table body 1 is depending on the number of the at least one support bracket 3 that is unfolded. When the at least one support bracket 3 is in the folded state, the at least one support bracket 3 swings to be substantially parallel to the bottom surface 101 of the table body 1. In this case, the rotation bracket 2 abuts against the placement surface such as the floor, the tabletop, and so on, and the table body 1 may be rotated relative to the placement surface through the rotation bracket 2.

Specifically, when the number of the at least one support bracket 3 is one, the table body 1 is inclined with respect to the placement surface when the support bracket 3 is in the in-use state. The in-use state may avoid the user from bending a vertebrate of the user for a long time. When the number of the at least one support bracket 3 is two or more, and when the two or more support bracket 3 are all in the in-use state, the table body 1 may lifted up with respect to the placement surface, such that a conventional table configuration is formed. In this way, the puzzle table can be used to place objects when not in use; and the puzzle table can provide a higher tabletop for the user when the user is tiling the puzzle pieces. When the rotation bracket 2 abuts against the placement surface, the table body 1 is disposed close to the placement surface, such that the puzzle table may be used for young children more conveniently.

Therefore, for the puzzle table, the rotation bracket 2 and the at least one support bracket 3 may be used to support the table body 1, and at least two usage modes are provided correspondingly to meet various demands of the user.

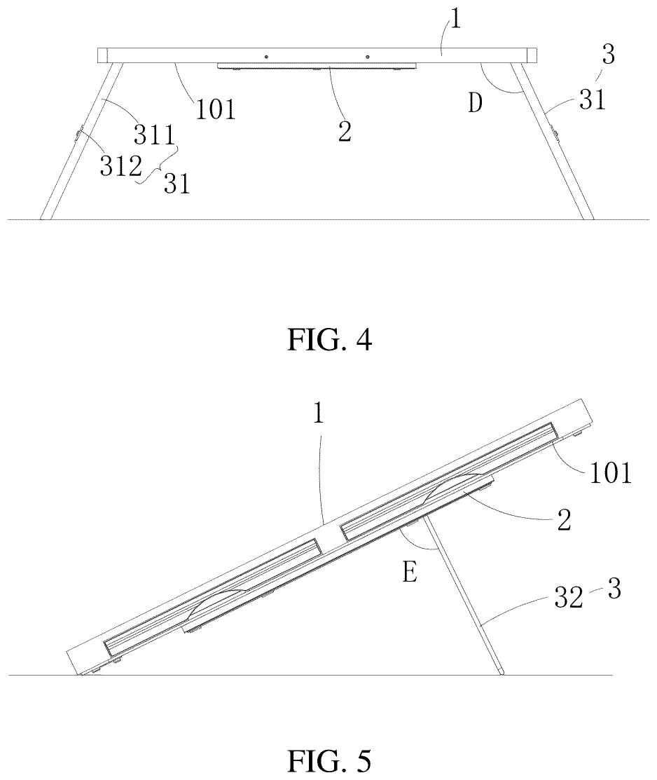

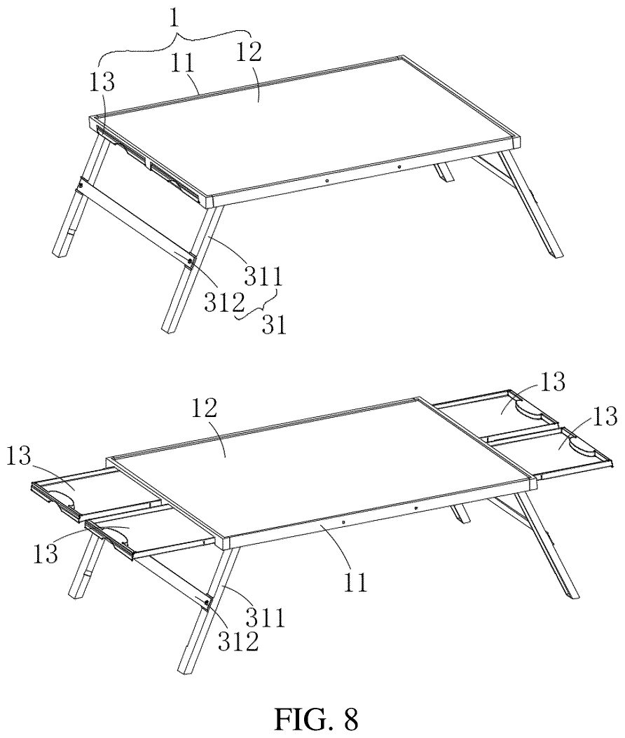

Further, as shown in FIGS. 4 and 8, the at least one support bracket 3 includes two side support brackets 31. The two side support brackets 31 are respectively rotatably mounted on two opposite sides of the table body 1. When the two side support brackets 31 are both in the in-use state, the two opposite sides of the table body 1 can be lifted up relative to the placement surface at the same time, such that a horizontal table body 1 is provided.

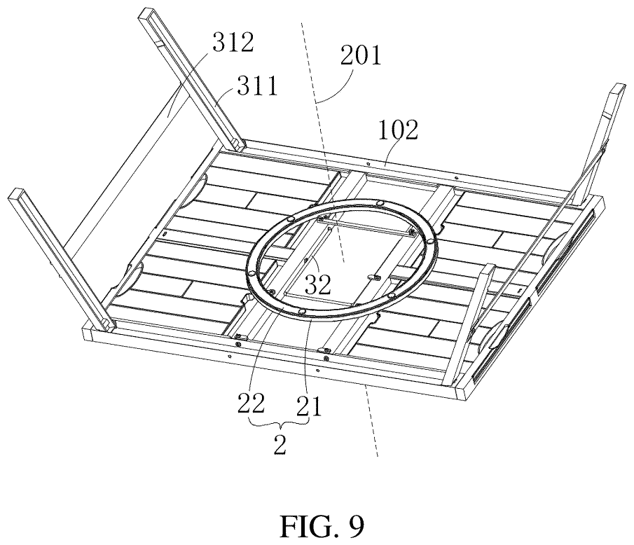

The rotation bracket 2 is ring-shaped or circular. The rotation bracket 2 is mounted at a center of the bottom surface 101 of the table body 1. The two side support brackets 31 are symmetrically distributed about the rotation bracket 2. In this way, overall balance of the table body 1 is improved. When the rotation bracket 2 abuts against the placement surface, a gravitational center of the table body 1 coincides with a rotation axis 201 of the rotation bracket 2, and a weight of the table body 1 is uniformly distributed at all positions. When the two side support brackets 31 abut against the placement surface, the gravitational center of the table body 1 is still located in the rotation axis 201 of the rotation bracket 2. The two side support brackets 31 are distributed in a mirrored symmetrical or centro-symmetrical manner about the rotation axis of the rotation bracket 201, as shown in FIG. 9, such that the weight of the table body 1 remains uniform at all positions.

Further, the bottom surface 101 of the table body 1 defines two storage slots 102 in parallel to each other. Each of the two side support brackets 31 includes two support legs 311. When the two side support brackets 31 are in the folded state, the two support legs 311 of each side support bracket 31 are respectively received in the two storage slots 102. Specifically, the two support legs 311 may be completely received in the two storage slots 102. That is, the table body 1 is square and has four support legs 311 in total to support four corners of the table body 1. Two support legs 311 of two side support brackets located on one side of the table body may be stored in one of the two storage slots 102. A length of each storage slot 102 is greater than a sum of lengths of the two support legs 311 of two side support brackets located on one side of the table body.

Further, as shown in FIGS. 1 and 8, each of the two side support brackets 31 includes at least one intermediate connection rod 312, the intermediate connection rod 312 is fixedly connected the two support legs 311 of one side support bracket 31. In this way, the two support legs 311 of each side support bracket 31 can be synchronously unfolded or folded.

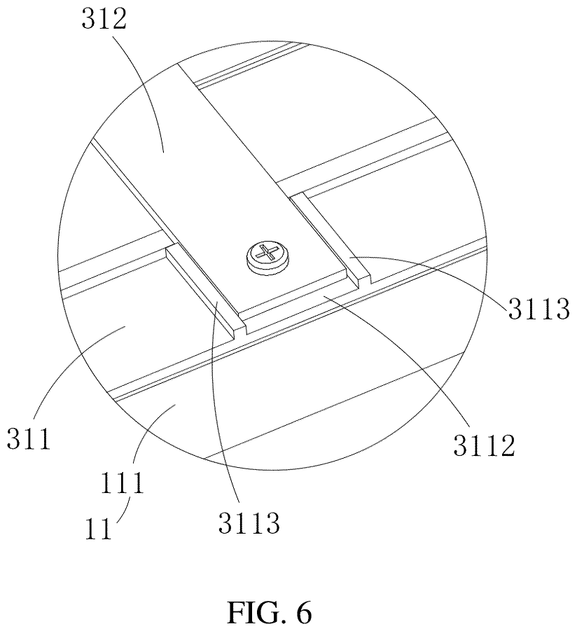

Specifically, as shown in FIG. 6, for each of the two support legs 311, a side 3111 of the support leg 311 away from the table body 1 defines a positioning groove 3112. Each of two ends of the intermediate connection rod 312 is received in the positioning groove 3112 of a respective one of the two support legs 311 and is fixed to the respective support leg 311 by screws. A side 3111 of each support leg 311 away from the table body 1 is arranged with two connection protrusions 3113. The positioning groove 3112 is defined between the two connection protrusions 3113.

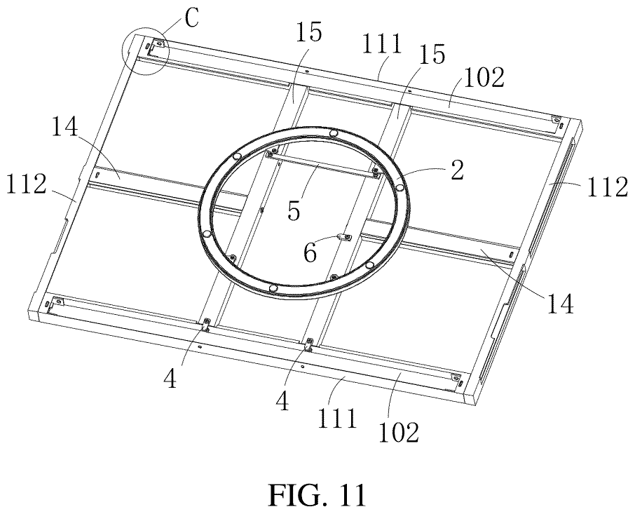

Further, as shown in FIGS. 1 and 11, the puzzle table further includes a first blocking member 4. The first blocking member 4 is rotatably mounted on the bottom surface 101 of the table body 1. When the side support bracket 31 is in the folded state, the first blocking member 4 may be rotated to abut against the side 3101 of the side support bracket 31 away from the table body 1. Specifically, the first blocking member 4 abuts against the support leg 311 to prevent the support leg 311 from swinging out of the storage slot 102 due to the gravity.

Further, as shown in FIGS. 4, 13, 14, 15, and 16, in order to limit configuration of the two side support brackets 31 when being in the in-use state, in the present embodiment, a limiting protrusion 103 is arranged on the table body 1. When the side support bracket 31 is in the in-use state, the side support bracket 31 abuts against the limiting protrusion 103 to prevent the support leg 311 of the side support bracket 31 from swinging continuously. A swing angle of the support leg 311 with respect to the bottom surface of the table body is greater than 90°, for example, an angle D shown in FIG. 4 is 120°.

Further, the support leg 311 of the side support bracket defines a fixation groove 3114. An end of the support leg 311 defining the fixation groove 3114 is inserted into the storage slot 102. When the side support bracket 31 is in the in-use state, the limiting protrusion 103 is inserted into the fixation groove 3114. The limiting protrusion 103 is horizontally extending, an abutting wall 3115 is formed on a side of the limiting protrusion 3114. When the side support bracket 31 is in the in-use state, the abutting wall 3115 is horizontally extending and abuts against the limiting protrusion 103. The weight of the table body 1 is carried by the abutting wall 3115. That is, a planar contact is formed between the support leg 311 and the table body 1 to increase a contact area therebetween. Specifically, a shaft body connecting the support leg and the table body serves as a rotation shaft of the side support bracket. When the support leg swings to an extreme position, the horizontal abutting wall abuts against the horizontal limiting protrusion. In this way, a lateral force applied to the support leg is reduced, and that is, a pulling effect applied by the support leg on the shaft body is reduced, and a service life of the shaft body is increased.

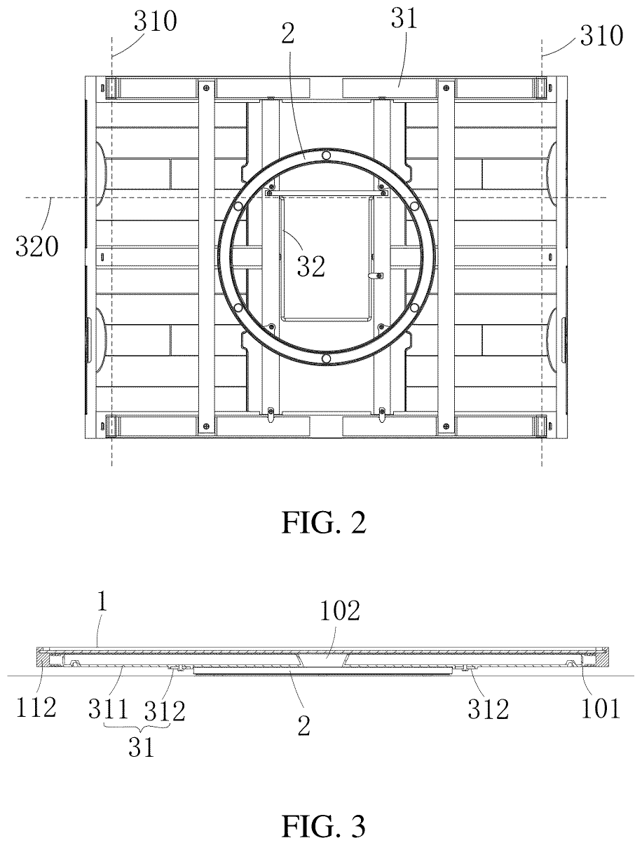

Further, as shown in FIGS. 1 and 2, the rotation bracket 2 is circular. The at least one support bracket 3 further includes a central support bracket 32. The central support bracket 32 is disposed at an inner side of the rotation bracket 2 and is rotatably mounted on the bottom surface 101 of the table body 1. The central support frame 32 is configured to enable the table body 1 to be placed inclined to the placement surface. The central support frame 32 and the two side support brackets 31 provides two usage modes. In addition, the central support frame 32 is disposed at the inner side of the ring-shaped rotation bracket 2, such that a larger rotation bracket 2 may be provided, stability of support of the rotation bracket 2 is improved. In order to adjust an inclination angle of the table body 1, in an embodiment, the central support bracket 32 may be configured as an extendable and retractable rod, which is not shown in the accompanying drawings.

Further, the central support bracket 32 is formed by bending a metal rod or a rod of other materials. The central support bracket 32 is “U”-shaped or “L”-shaped. Only the “U”-shaped central support bracket 32 is shown in the accompanying drawings, which has a more stable support structure. Specifically, the rotation axis 310 of the side support bracket 31 is perpendicular to a rotation axis 320 of the central support bracket 32. In this way, a placement plane on which the central support bracket 32 is located is perpendicular to a swing plane on which the side support bracket 31 swings. The two side support brackets 31 are connected to two short edges of the table body 1. When the central support bracket 32 is unfolded and supported on the placement surface, one of two long edges of the table body I also abuts against the placement surface, and the other one of the two long edges is located away from the placement surface. Of course, in other embodiments, two central support brackets may be arranged, and the rotation axis of the central support bracket is parallel to the rotation axis of the side support bracket. That is, the two central support brackets may be treated as two side support brackets which are arranged at the inner side of the annular rotation bracket and have smaller sizes. Alternatively, in another embodiment, the central support bracket may be disposed outside the rotation bracket, such that the central support bracket may be “U” shaped, and the rotation bracket is located inside the central support bracket.

Specifically, the puzzle table of the present embodiment has the following three usage modes. When the side support brackets are in the in-use state, the central support bracket is in a folded state, and the side support brackets abut against the placement surface as shown in FIG. 4. When the central support bracket is in the in-use state, the side support brackets are in the folded state, and the central support bracket abuts against the placement surface as shown in FIG. 5. When the side support brackets and the central support bracket are both in the folded state, the rotation bracket abuts against the placement surface, as shown in FIG. 3.

Further, the puzzle table further includes a limiting gear lever 5. The limiting gear lever 5 is fixedly mounted on the bottom surface 101 of the table body 1. When the central support bracket 32 is in the in-use state, the central support bracket 32 abuts against the limiting gear lever 5 to limit a swing angle of the central support bracket. A range of the swing angle of the central support bracket 32 is greater than or equal to 90°, for example, an angle E shown in FIG. 5 is 90°.

Further, as shown in FIGS. 1, 10 and 11, the puzzle table further includes a second blocking member 6. The second blocking member 6 is rotatably mounted on the second reinforcing rod 15. When the central support bracket 32 is in the folded state, the second blocking member 6 may swing to abut against a side of the central support bracket 32 away from the table 1, so as to prevent the central support bracket 32 from being naturally unfolded under the gravity.

Further, as shown in FIGS. 11 to 16, the table body 1 includes a frame 11, a table board 12, and a plurality of drawers 13. The frame 11 includes two parallel long rods 111, two parallel side rods 112, two first reinforcing rods 14, and two second reinforcing rods 15. The two long rods 111 and the two side rods 112 cooperatively enclose to form the square frame 11. The table board 12 is fixed to a center of the square frame 11. Four sides of the table board 12 are respectively connected to the two long rods 111 and the two side rods 112. The plurality of drawer 13 are slidably mounted on the two side rods 112 along a length direction of the long rods 111. The plurality of drawer 13 are disposed underneath the table board 12. Each of the two side rods 112 is mounted with two drawers 13 of the plurality of drawers 13, and the two drawers 13 are mounted in parallel to each other. A rotation axis 320 of the central support bracket 32 is parallel to a sliding direction of the plurality of drawers 13. The two long rods 111 serve as two long sides of the table body 1, and the two side rods 112 serve as two short sides of the table body 1. In some embodiments, the two long rods are made of metal, and the two side rods are made of plastic.

Specifically, the storage slot 102 is defined in each of the two long rods 111 and extends in the length direction of the long rod 111. A bottom surface of each long rod 111 serves as a bottom surface of the frame 11, and the bottom surface of the frame 11 serves as the bottom surface 101 of the table body 1. When the support leg 311 is received in the storage slot 102, the side 3111 of the support leg 311 away from the table body 1 is aligned with or protrudes from the bottom surface of the long rod 111. A thickness of the intermediate connection rod 312 is less thick than a thickness of the rotation bracket 2. Therefore, when the side support brackets 31 are in the folded state, only the rotation bracket 2 abuts against the placement surface, preventing the side support brackets 31 from abutting against the placement surface.

The long rod 111 further defines a mounting groove 1111 communicated with the storage slot 102. The mounting groove 1111 extends through the long rod 111 in the length direction. The side rod 112 is arranged with a connection portion 1121 extending along the length direction of the long rod 111, and the connection portion 1121 protrudes from the long rod 111. The connection portion 1121 is inserted into and is snapped with the mounting groove 1111. One end of the support leg 311 of the side support bracket 31 extends into the storage slot 102 and is rotatably mounted to the connection portion 1121. Specifically, the end of the support leg 311 is hinged to or pivoted to the connection portion 1121.

The side rod 112 and the long rod 111 are fixed to each other by snapping, such that disassembling and assembling can be achieved easily. A snap hook 1122 is arranged on the connection portion 1121, and the long rod 111 defines a snap slot 1112 communicated with the mounting groove 1111. After the connection portion 1121 is inserted into the mounting groove 1111, the snap hook 1122 is snapped into the snap slot 1112. It is understood that, in other embodiments, the connection portion 1121 may be arranged on the long rod 111, and the mounting groove 1111 may be defined in the side rod 112, and the same snapping effect can be achieved.

In addition, two first reinforcing rods 14 are in parallel or co-linear with each other. The first reinforcing rods 14 are parallel to the long rods 111, and the two second reinforcing rods 15 are both parallel to the side rods 112, and that is, the first reinforcing rods 14 are perpendicular to the second reinforcing rods 15. An end of each first reinforcing rod 14 is fixedly connected to one of the two side rods 112, and the other end of the first reinforcing rod 14 is fixedly connected to one of the two second reinforcing rods 15. Two ends of each second reinforcing rod 15 are respectively fixedly connected to the two long rods 111. The rotation bracket 2 is fixedly connected to both the two first reinforcing rods 14 and the two second reinforcing rods 15. Fixed connection between the first reinforcing rod 14 and the side rod 112 may be the same as the connection between the long rod 111 and the side rod 112, such as shown in FIG. 15. Alternatively, all of the above fixed connection may be achieved by bolts.

Two first blocking members 4 may be arranged. The two first blocking members 4 are respectively rotatably mounted on the two second reinforcing rods 15. The two first blocking members 4 are configured to block the two side support brackets 31. Each first blocking member 4 may be connected to the second reinforcing rod 15 by bolts. The central support bracket 32 is disposed between the two second reinforcing rods 15. Two ends of the central support bracket 32 are inserted into the two second reinforcing rods 15 respectively, so as to achieve rotatable connection. One limiting gear lever 5 and one second blocking member 6 may be arranged. Two ends of the limit gear lever 5 are fixed to the two second reinforcing bars 15 respectively via bolts. The second blocking member 6 is rotatably mounted on either one of the two second reinforcing rods 15, and the second blocking member 6 may be connected to the second reinforcing rod 15 by bolts.

The first reinforcing rods 14 and the second reinforcing rods 15 are both arranged to improve structural stability of the frame 11 and to support the table board 12. It is understood that the number of first reinforcing rods 14 and the number of second reinforcing rods 15 may be large, the larger number of first reinforcing rods 14 and the larger number of second reinforcing rods 15 may improve stability of the frame 11.

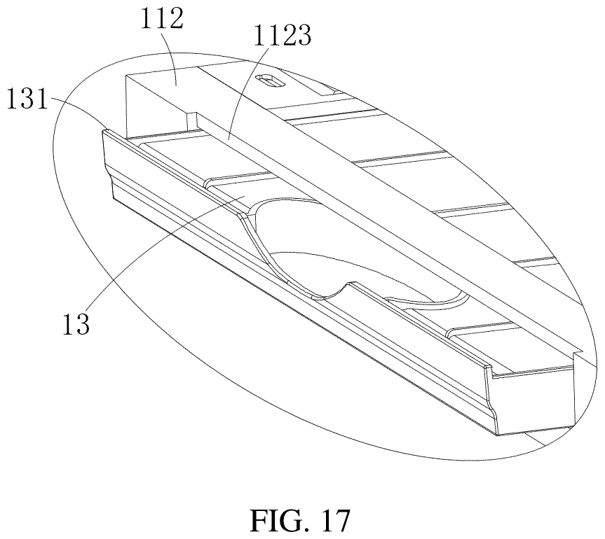

As shown in FIGS. 1 and 17, a front end of each drawer 13 is arranged with a snap tab 131. A length of the drawer 13 is shorter than a length of the first reinforcing rod 14. In this way, when the drawer 13 is slid inwardly to reach a most interior position, the snap tab 131 abuts against the side rod 112. A snap slot 1123 is defined in the side rod 112 corresponding to the snap tab 131. In this way, a gap is formed between a rear end of the drawer 13 and the second reinforcing rod 15, as shown in FIG. 1.

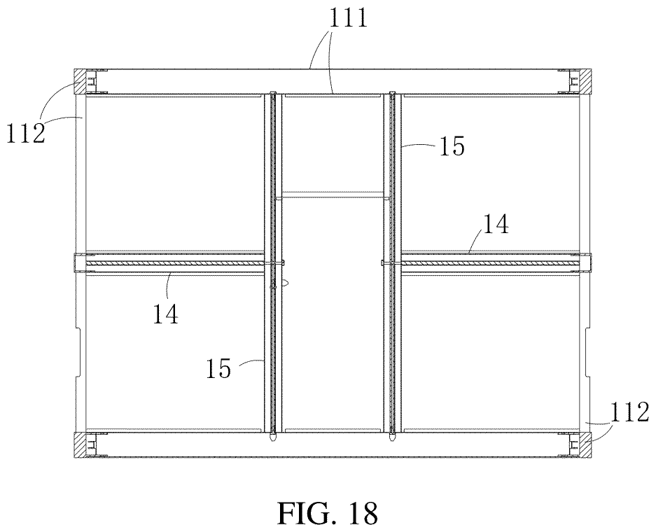

Further, as shown in FIG. 18, each of the long rod 111, the side rod 112, the first reinforcing rod 14, and the second reinforcing rod 15 is configured as a hollow tube. In this way, materials are saved, and a weight is reduced.

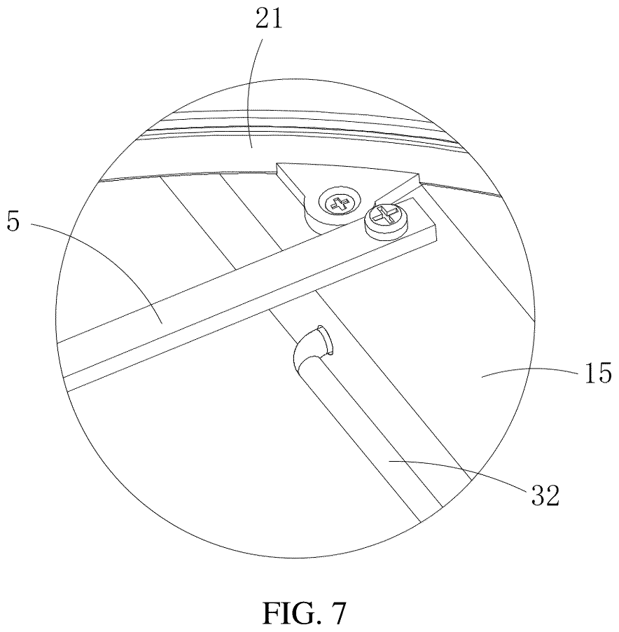

As shown in FIG. 9, the rotation bracket includes an annular fixation shell 21 and an annular base 22. The fixation shell 21 is fixedly connected, by bolts, to the first reinforcing rod 14, the second reinforcing rod 15 and/or the table board 12. The fixation shell sleeves the base from top to bottom. Rolling balls are arranged between the base and the fixation shell. In this way, rotatable connection between the base and the fixation shell is achieved. The fixation shell 21 is mounted to the table body via an easily removable connection structure. The easily removable connection structure may be connecting bolts to an inside and/or an outside of the fixation shell 21 as shown in FIG. 7, such that the bolts are mounted to the second reinforcing rod 15. In other embodiments, the easily removable connection structure may be glue, magnetic attraction, and so on.

Obviously, the above-described embodiments show only a part of, not all of, the embodiments of the present disclosure. The accompanying drawings provide preferred embodiments of the present disclosure without limiting the scope of the present disclosure. The present disclosure may be achieved in various forms. These embodiments are provided for the purpose of understanding the present disclosure more thoroughly and comprehensively. Although the present disclosure has been described in detail with reference to the foregoing embodiments, any ordinary skilled person in the art may modify the technical solutions recorded in the foregoing specific embodiments or to make equivalent substitutions for some of the technical features therein. Any equivalent structure performed based on the contents of the specification and the accompanying drawings of the present disclosure, applied directly or indirectly in other related technical fields, shall all be equivalently included in the scope of the present disclosure.

What is claimed is:

1. A puzzle table, comprising:
a table body;
a rotation bracket, mounted on and parallel to a bottom surface of the table body, wherein the rotation bracket is configured to enable the table body to rotate on a horizontal plane;
and at least one support bracket, rotatably mounted on the table body, wherein the at least one support bracket has an in-use state and a folded state; when the at least one support bracket is in the in-use state, the at least one support bracket abuts against a placement surface; and when the at least one support bracket is in the folded state, the at least one support bracket swings to be substantially parallel to the bottom surface of the table body, and the rotation bracket abuts against the placement surface.

2. The puzzle table according to claim 1, wherein the at least one support bracket comprises two side support brackets; and the two side support brackets are respectively rotatably mounted on two opposite sides of the table body.

3. The puzzle table according to claim 2, wherein the rotation bracket is mounted at a center of the bottom surface of the table body; and the two side support brackets are symmetrically distributed about the rotation bracket.

4. The puzzle table according to claim 2, wherein the bottom surface of the table body defines two storage slots that are in parallel to each other; each of the two side support brackets comprises two support legs; when the two side support brackets are in the folded state, the two support legs of each of the two side support brackets are respectively received in the two storage slots; and each of the two storage slots receives one of the two support legs of one of the two side support brackets and one of the two support legs of the other one of the two side support brackets.

5. The puzzle table according to claim 4, wherein a length of each of the two storage slots is greater than a sum of lengths of one of the two support legs of one of the two side support brackets and one of the two support legs of the other one of the two side support brackets.

6. The puzzle table according to claim 4, wherein each of the two side support brackets comprises an intermediate connection rod, the intermediate connection rod is fixedly connected the two support legs of the side support bracket.

7. The puzzle table according to claim 6, wherein a side of each of the two support legs away from the table body defines a positioning groove; each of two ends of the intermediate connection rod is received in the positioning groove of a respective one of the two support legs and is fixed to the respective one of the two support legs by a bolt.

8. The puzzle table according to claim 2, wherein the puzzle table further comprises a first blocking member; the first blocking member is rotatably mounted on the bottom surface of the table body; when each of the two side support brackets is in the folded state, the first blocking member is configured to be rotated to abut against a side of the side support bracket away from the table body.

9. The puzzle table according to claim 2, wherein a limiting protrusion is arranged on the table body; when at least one of the two side support brackets is in the in-use state, the at least one side support bracket abuts against the limiting protrusion; and a swing angle of the support leg with respect to the bottom surface of the table body is greater than 90°.

10. The puzzle table according to claim 9, wherein each of the two side support brackets defines a fixation groove; when the at least one side support bracket is in the in-use state, the limiting protrusion is inserted into the fixation groove.

11. The puzzle table according to claim 10, wherein the limiting protrusion is horizontally extending; an abutting wall is formed on a side of the limiting protrusion; when the at least one side support bracket is in the in-use state, the abutting wall is horizontally extending and abuts against the limiting protrusion.

12. The puzzle table according to claim 1, wherein the rotation bracket is annular; the at least one support bracket further comprises a central support bracket; the central support bracket is disposed at an inner side of the rotation bracket and is rotatably mounted on the bottom surface of the table body.

13. The puzzle table according to claim 12, wherein the at least one of support bracket further comprises two side support brackets; the two side support brackets are respectively rotatably mounted on two opposite sides of the table body; a rotation axis of each of the two side support brackets is perpendicular to a rotation axis of the central support bracket.

14. The puzzle table according to claim 13, wherein the table body comprises a frame and a plurality of drawers; the plurality of drawer are slidably mounted on the frame along a length direction of the frame; the rotation axis of the central support bracket is parallel to a sliding direction of the plurality of drawers.

15. The puzzle table according to claim 12, wherein the puzzle table further comprises a limiting gear lever; the limiting gear lever is fixedly mounted on the bottom surface of the table body; when the central support bracket is in the in-use state, the central support bracket abuts against the limiting gear lever; and a range of a swing angle of the central support bracket is greater than or equal to 90°.

16. The puzzle table according to claim 12, wherein the puzzle table further comprises a second blocking member; the second blocking member is rotatably mounted on the bottom surface of the table body; when the central support bracket is in the folded state, the second blocking member is configured to swing to abut against a side of the central support bracket away from the table body.

17. The puzzle table according to claim 1, wherein the table body comprises a frame, a table board, and a plurality of drawers;
the frame comprises two parallel long rods and two parallel side rods; the two long rods and the two side rods cooperatively enclose the table board; the plurality of drawers are slidably mounted on at least one of the two side rods along a length direction of the two long rods; and the plurality of drawers are located underneath the table board; and
the at least one support bracket is rotatably mounted on one of the two long rods or one of the two side rods.

18. The puzzle table according to claim 17, wherein each of the two long rods defines a storage slot the length direction thereof and a mounting groove communicated with the storage slot; the mounting groove extends through the long rod;
each of the two side rods is arranged with a connection portion extending in the length direction of the long rod, and the connection portion is inserted into the mounting groove;
the at least one of support bracket extends into the storage slot and is rotatably mounted on the connection portion; when the at least one support bracket is in folded state, at least a part of the at least one support bracket is received in the storage slot.

19. The puzzle table according to claim 17, wherein a snap hook is arranged on the connection portion, and each of the two long rods defines a snap slot communicated with the mounting groove; the snap hook is capable of being snapped into the snap slot.

20. The puzzle table according to claim 17, wherein the table body further comprises a first reinforcing rod and a second reinforcing rod; the first reinforcing rod is parallel to the two long rods and is fixedly connected to the two side rods; the second reinforcing rod is parallel to the two side rods and is fixedly connected to the two long rods; the rotation bracket is fixedly connected to the first reinforcing rod and/or the second reinforcing rod.
